(19) United States
(12) Patent Application Publication
(10) Pub. No.: US 2003/0177163 A1
(43) Pub. Date: Sep. 18, 2003

(54) Microprocessor comprising load monitoring function

(75) Inventor: Katsunobu Nomura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/388,560

(22) Filed: Mar. 17, 2003

(30) Foreign Application Priority Data
Mar. 18, 2002 (JP) 2002-73577

(51) Int. Cl. G06F 9/00

(52) U.S. Cl. 709/102

(57) ABSTRACT

A microprocessor that operates in synchronization with clocks, comprising: a first counter for counting the clocks; a second counter for counting the clocks during periods when the microprocessor is in a sleep state; a counter control circuit for controlling resetting or enabling/disabling of the first and second counters; a control register for directing an operation of the counter control circuit; a load calculation circuit for finding a load of the microprocessor from the respective count values of the first and second counters; and a load monitoring circuit including a load register for storing the load found by the load calculation circuit, wherein the control register and load register are accessible by a program or an external terminal. It is possible to optionally set the timing of the load monitoring, and to read out the monitoring results from the load register, whereby more flexible load monitoring is permitted.

### BACKGROUND OF THE INVENTION

### CROSS-REFERENCE TO RELATED APPLICATIONS

This application is based upon and claims the benefit of priority from the prior Japanese Patent Application No. 2002-73577, filed on Mar. 18, 2002, the entire contents of which are incorporated herein by reference.

1. Field of the Invention

The present invention relates to a microprocessor comprising a load monitoring function, and more particularly to a microprocessor comprising a load monitoring function that permits the load monitoring timing to be set from the outside, or a load monitoring function for self-setting, continuous monitoring of the load.

2. Description of the Related Art

With the object of suppressing electrical power consumption, the microprocessor is capable of a transition to a sleep state in accordance with a sleep command, or a sleep request from an external terminal. In order to run applications more efficiently by means of the microprocessor, monitoring of the load of the microprocessor is effective. Monitoring the load and thus increasing the task amount when the load is light, and, conversely, reducing the task amount when the load is heavy, makes it possible to operate the microprocessor efficiently.

FIG. 1 shows an example of conventional task management. In the example, the tasks 1, 2, and 3 (“task#1”, “task#2”, and “task#3” in the figure) are executed as a result of running a user application program 50, and, when none of the tasks are being executed, a sleep state, that is, an idle state (“idle” in the figure) is assumed. Here, load monitoring is performed by finding the ratio between the time interval T1+T2+T3 in which the tasks are executed from time T0 until T0+Td, and the total time interval Td (the ratio (T1+T2+T3)/Td).

One method fulfilling this purpose is to provide an operating system (OS) with a load monitoring task 52, which calculates the respective time intervals of a state in which the processor is executing a task as well as those of an idle state, and to execute this load monitoring task 52 repetitively at regular intervals. That is, as one function which the OS provides is that of finding the processor load is found by means of software.

However, with such a method of providing a monitoring task as an OS function and executing this task at regular intervals, since it is necessary to execute a monitoring task in addition to an original task, therefore it is not possible to precisely monitor the processor load that accompanies the execution of the original task, as a result of the generation of the overhead involved in the monitoring task execution, and as a result of intermittent monitoring task execution. Moreover, raising the frequency of execution of the monitoring task 52 makes it possible to improve the accuracy but the processor is then subjected to an extra load, and reducing the frequency of execution allows the load to be reduced, but there is then conversely a drop in the accuracy.

As an alternative to a monitoring task provided by an OS, it has been proposed to incorporate in the processor a first counter for counting system clocks and a second counter for counting system clocks during sleep periods, and calculate the ratio between the counters. Such a load monitoring circuit was disclosed by Unexamined Japanese Patent application (Kokai) No. H4-98540 (application published on Mar. 31, 1992), for example.

However, the above-cited prior art only discloses two counters inside the processor, and a counter reading section for reading out the count values of these counters and calculating the ratio between the count values. There is no disclosure whatever with regard to the method for the startup of such a load monitoring circuit, nor for the reading out of the load. Therefore, such prior art cannot be said to be a circuit constitution for monitoring the load that is suited to a variety of objects.

### SUMMARY OF THE INVENTION

Accordingly, it is an object of the present invention to provide a microprocessor equipped with a load monitoring function permitting the user to monitor the load with optional timing.

It is a further object of the present invention to provide a microprocessor comprising a function that permits the microprocessor to monitor, by means of self-setting, the load that accompanies task execution by the microprocessor.

In order to achieve the above objects, one aspect of the present invention is a microprocessor that operates in synchronization with clocks, comprising: a first counter for counting the clocks; a second counter for counting the clocks during periods when the microprocessor is in a sleep state; a counter control circuit for controlling resetting or enabling/disabling of the first and second counters; a control register for directing an operation of the counter control circuit; a load calculation circuit for finding a load of the microprocessor from the respective count values of the first and second counters; and a load monitoring circuit including a load register for storing the load found by the load calculation circuit, wherein the control register and load register are accessible by a program or an external terminal.

According to the above aspect of the invention, by suitably setting the resetting or enabling/disabling of the first and second counters in the control register, it is possible to optionally set the timing of the load monitoring, and to read out the monitoring results from the load register, whereby more flexible load monitoring is permitted.

In order to achieve the above objects, another aspect of the present invention is a microprocessor that operates in synchronization with clocks, comprising: a first counter for counting the clocks; a second counter for counting the clocks during periods when the microprocessor is in a sleep state; a counter control circuit for controlling resetting or enabling/disabling of the first and second counters; a load calculation circuit for finding a load of the microprocessor from the respective count values of the first and second counters; and a load monitoring circuit including a load register for storing the load found by the load calculation circuit, wherein, in response to a timing signal generated when the first counter reaches a predetermined count value, the load calculation circuit finds the load and outputs the load to the load register, and the counter control circuit resets the first and second counters to start the count.

According to another aspect of the invention, because the counter control circuit resets the first and second counters in response to a timing signal generated by the first counter, the load calculation circuit outputs the load calculation result to the load register at regular intervals, and the first and second counters start the clock count required for the load calculation. The load monitoring circuit can thus be operated by means of a self-setting system.

In a more preferable embodiment, the load register is capable of storing a plurality of load calculation results and storing a load history. It is therefore possible to determine the loads of optional periods by suitably reading out the load history of the load register.

### BRIEF DESCRIPTION OF THE DRAWINGS

FIG. 1 shows an example of conventional task management;

FIG. 2 is a constitutional view of the microprocessor according to the present embodiment;

FIG. 3 serves to illustrate the operation of the load monitoring circuit in FIG. 2;

FIG. 4 shows an application example of the load monitoring circuit of a first embodiment;

FIG. 5 shows large and small load amounts;

FIG. 6 shows a load monitoring circuit 16 that is applied to the example in FIG. 4;

FIG. 7 shows another load monitoring circuit according to the first embodiment;

FIG. 8 shows yet another load monitoring circuit according to the first embodiment;

FIG. 9 shows an application example of the load monitoring circuit of a second embodiment;

FIG. 10 shows a preferred example of a load monitoring circuit in a processor in the multiprocessor in FIG. 9; and

FIG. 11 shows another preferred example of a load monitoring circuit in a processor in the multiprocessor in FIG. 9.

### DESCRIPTION OF THE PREFERRED EMBODIMENTS

The embodiments of the present invention will be described hereinbelow with reference to the drawings. However, the scope of protection of the present invention is not limited to or by the embodiments below, but rather covers the inventions defined in the claims as well as any equivalents thereof.

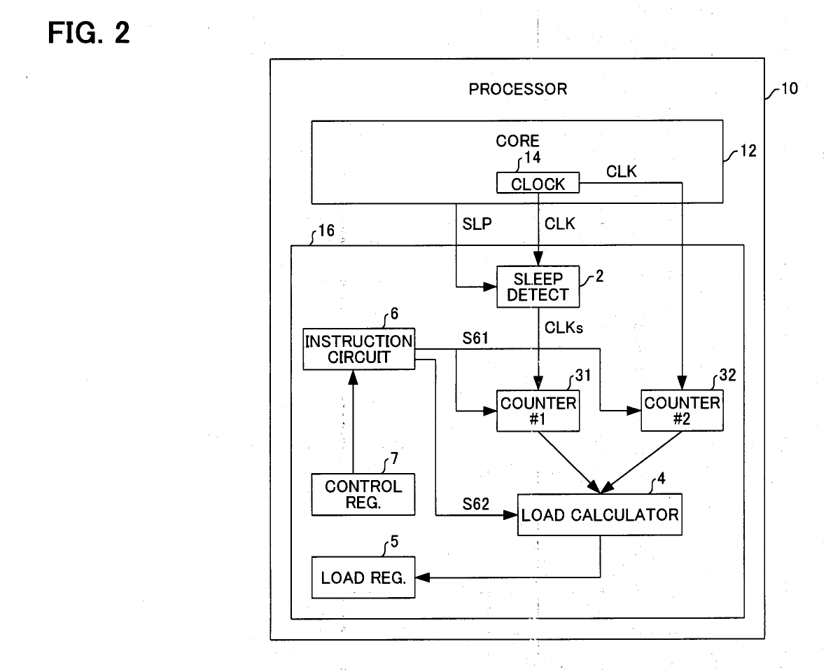

FIG. 2 is a constitutional view of a microprocessor according to a first embodiment. Microprocessor 10 comprises a load monitoring circuit 16 in addition to a core 12 comprising a programmable ROM, a RAM, a program counter, a command decoder, a processor circuit, a register group, and the like. The core 12 operates in synchronization with internal clocks CLK that a regenerated by a clock generating circuit 14. The load monitoring circuit 16 comprises a first counter 32 for counting the clocks CLK; a second counter 31 for counting the clocks CLK in periods when the core 12 is in a sleep state; and a load calculation circuit 4 for latching the count values of the counters 32, 31, calculating the ratio between these values, and writing the calculation result to the load register 5. The load monitoring circuit 16 further comprises an instruction circuit (counter control circuit) 6 for controlling the resetting (initialization) of the counters 31, 32, and controlling the start and stop (enable, disable) of the count operation. The load monitoring circuit 16 also comprises a control register 7 and a load register 5 which are accessible by a program from the outside or by an external terminal.

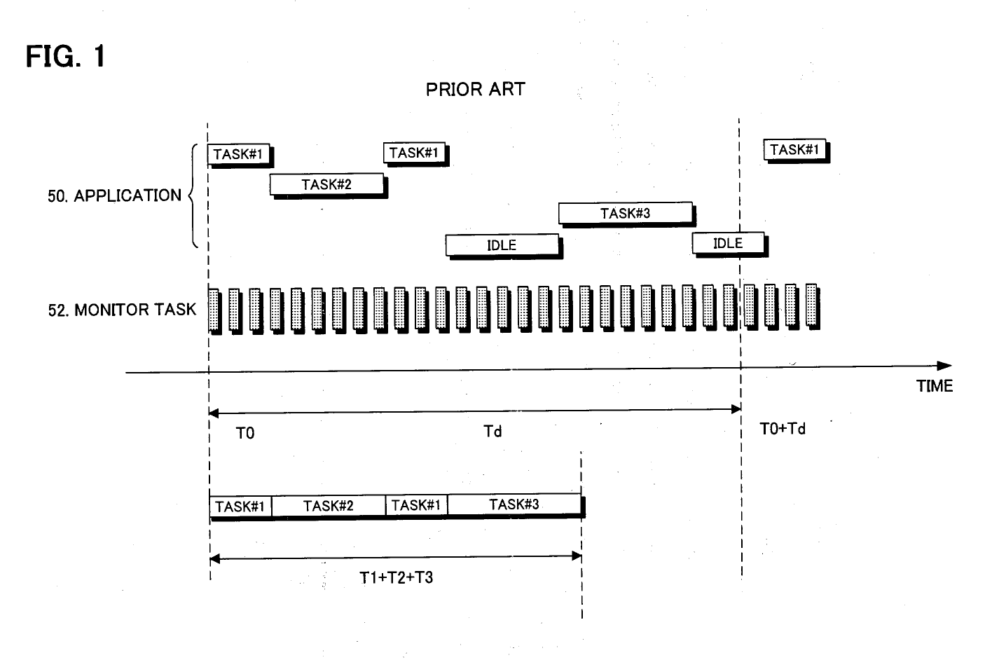

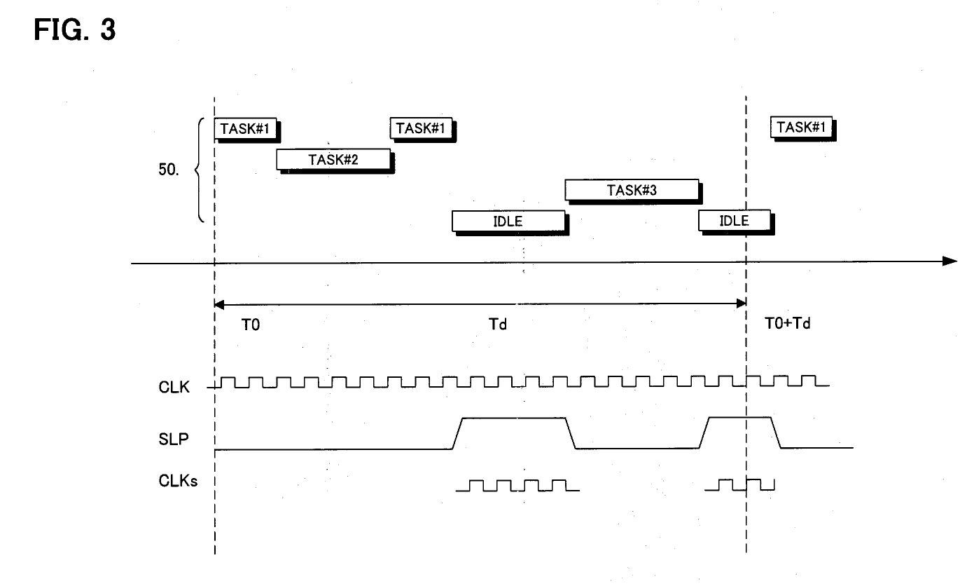

FIG. 3 serves to illustrate the operation of the load monitoring circuit in FIG. 2. Also in FIG. 3, three tasks (task#1, task#2, and task#3) are executed in order to run the application program 50 similarly to FIG. 1, and during periods when these tasks are not being executed, the processor assumes a sleep state (“idle” in the figure).

When resetting is set upon access to the control register 7, the instruction circuit 6 resets (initializes) the counters 31, 32 in response, and when enable is set, starts the count. Accordingly, the first counter 32 sequentially counts the internal clocks CLK of the processor core 12. A sleep detection circuit 2 therefore supplies clocks CLKs to the first counter 32 so as to allow the internal clocks CLK to pass, while a sleep state signal SLP from the core 12 is of a sleep state (at the high level). The second counter 31 accordingly counts the clocks CLKs of the sleep periods.

In response to any given command, such as when a read command to read the load register 5 or a load calculation instruction command is generated, the load calculation circuit 4 latches the count values of the counters 32, 31, calculates the ratio between these values, and writes the calculation result value indicating the load, to the load register 5. As a result, a value in the load register which indicates the load is read out.

Flags, which instruct the instruction circuit 6 to reset (initialize) and enable/disable the counters, are initially written to the control register 7. The control register 7 is accessible from the outside, and when these flags are written, the instruction circuit 6 decodes the flags and supplies a reset signal or enable/disable signal S61 to the counters 32, 31. It is thus possible to externally control the timing of the start and termination of the count by the counters.

Secondly, a load calculation flag, which causes the instruction circuit 6 to supply a load calculation instruction signal to the load calculation circuit 4, can also be written to the control register 7. Here, the instruction circuit 6 decodes the load-calculation flag and supplies the load calculation instruction signal S62 to the load calculation circuit 4 at the time the load calculation flag is written. In response to this signal S62, the load calculation circuit 4 calculates the load by latching the count values of the counters 31, 32. It is therefore possible to control the timing of the load calculation from outside. As illustrated by FIG. 1, the load calculation is a processing to divide the count value of the second counter 31 by the count value of the first counter 32.

In another method, writing a reset flag to the control register 7 clear the count values of the counters 31, 32, which are in an enabled state, to zero and starts the count of the counters, and, in response to a read command to read the load register 5, a load calculation signal (not illustrated) from the core 12 is supplied to the load calculation circuit 4. It is accordingly possible to optionally control the start timing and termination timing of the load monitoring at the time of accessing the registers 7, 5.

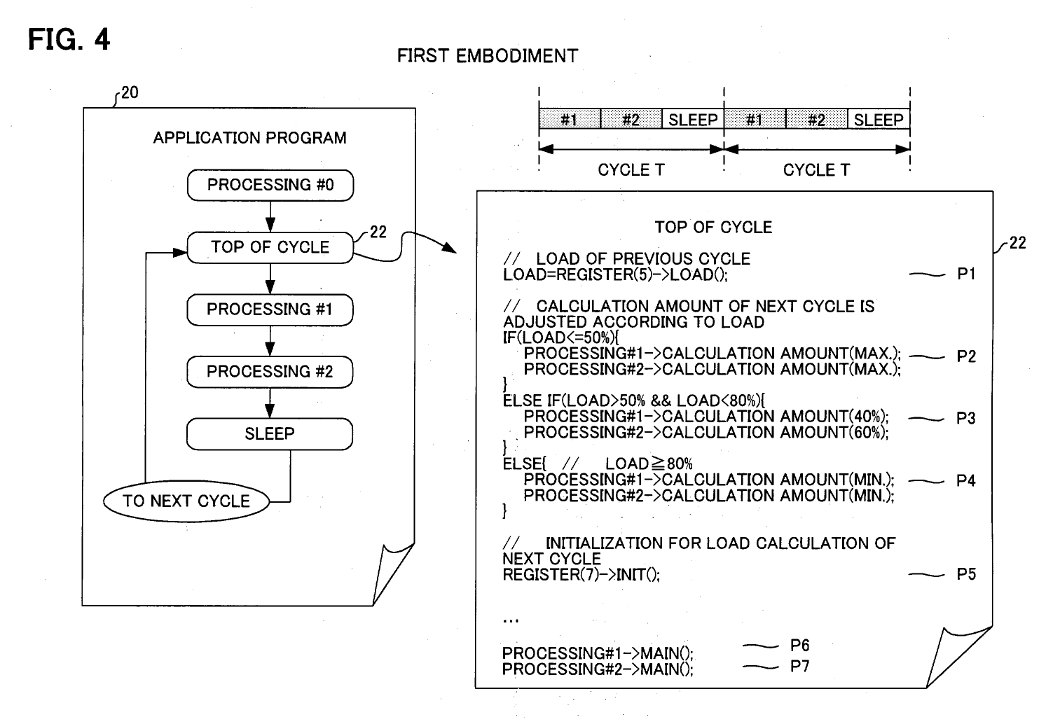

FIG. 4 shows an application example of the load monitoring circuit of the first embodiment. Let us suppose that a given application program 20 executes processing #0, whereupon processing #1 and processing #2 are executed during a period of a cycle T, this process being repeated cyclically. A signal processing processor such as a digital signal processor (DSP) often cyclically repeats the same data processing #1, #2 as above. In such a case, the processing #1, #2 is executed in a period of the cycle T, and during the remaining cycle time the processor is in a sleep state.

In cases where the above processing #1, #2 is a processing whose processing result accuracy can be improved by increasing the iterative processing frequency, for example, it is preferable to execute processing #1, #2 as much as possible in the period of cycle T. In such a case, if the load state of the processor in each cycle T can be monitored by using the load monitoring circuit of the present embodiment, the processing amount of the processing #1, #2 of the next cycle can be adjusted in accordance with the previous load state.

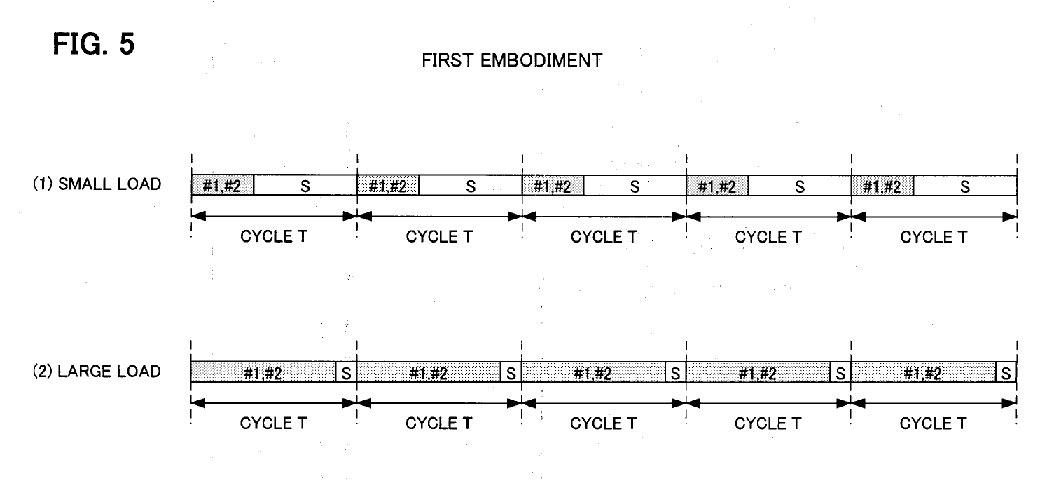

FIG. 5 shows large and small load amounts. In FIG. 5, (1) is a case where the load amount is small, and hence the time interval of the sleep state (“s” in the figure) is long in comparison with the time interval during which the processing #1, #2 is executed in each cycle T. On the other hand, (2) is a case where the load amount is large, and hence the time interval during which the processing #1, #2 is executed in each cycle T is longer than the time interval of the sleep state (“s” in the figure). It is therefore preferable to use the load monitoring circuit to exercise control to increase the processing amount of the processing #1, #2 if the state of (1) is detected, and to reduce the processing amount of the processing #1, #2 if the state of (2) is detected. It is thus possible to perform control such that, when the load in the previous cycle is light, the processing frequency of the processing is increased based on the expectation that the load will also be light in subsequent cycles, and when the load in the previous cycle is heavy, the processing frequency of the processing in subsequent cycles is reduced such that the processing #1, #2 is completed within the cycle T.

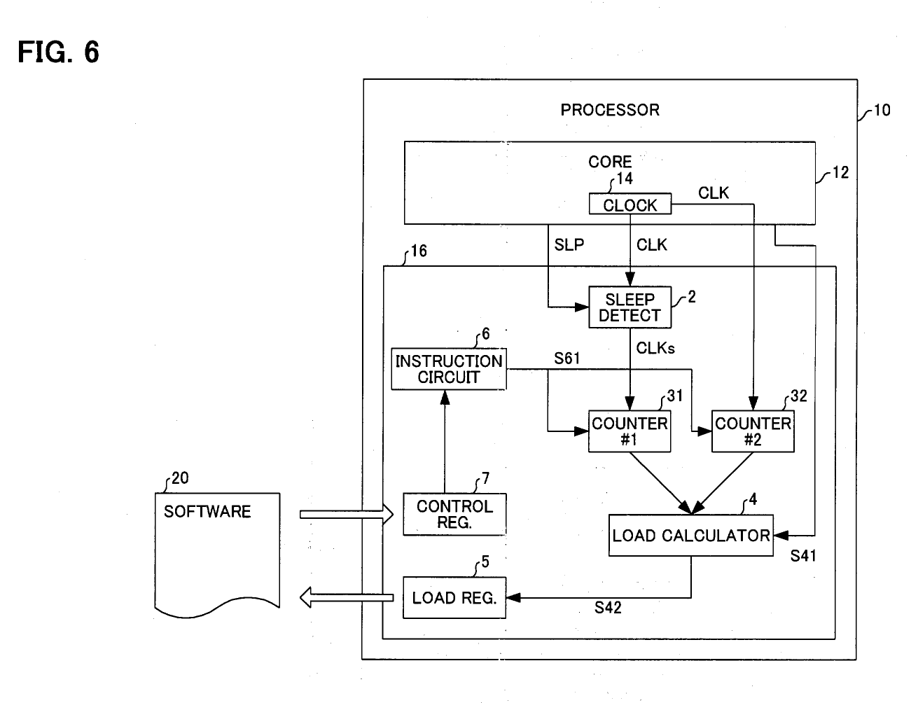

FIG. 6 shows a load monitoring circuit 16 that is applied to the example in FIG. 4. The constitution of the load monitoring circuit 16 is the same as that in FIG. 2. However, the control register 7 and load register 5 are constituted so as to be accessible by an external program 20. In addition, the counters 31, 32 are continuously set to an enabled state, such that when a reset flag is written by the program 20 to the control register 7, this is detected by the instruction circuit 6, and the counters 31, 32 are reset (initialized) by the reset signal S61. As a result, the clock count is started. Further, when a read command to read the load register 5 is outputted by the external program 20, a load calculation signal S41 is supplied by the core 12 to the load calculation circuit 4 in response to the read command, whereupon the load calculation circuit 4 calculates the load by latching the respective count values of the counters 31, 32, and writes the load calculation result S42 to the load register 5. The external program 20 is thus capable of reading out the load calculation result.

Returning to FIG. 4, a description will now be provided for the cycle header program 22 in the program 20. This program 22 comprises the procedures P1 to P5. First, in procedure P1, the value of the load register 5 is provided as the variable “Load”. Specifically, in response to a read command to read the load register 5 in procedure P1, the processor core 12 supplies the load calculation signal S41 to the load calculation circuit 4. By way of response, the load calculation circuit 4 latches the respective count values of the counters 31, 32 to perform the load calculation, and then writes the calculation result S42 to the load register 5. The load amount written to the load register 5 is provided as the variable “Load”. Next, the program 22 changes the processing amount of the processing #1, #2 to the maximum when the variable “Load” indicating the previous processor load amount is equal to or less than 50% (procedure P2), changes the processing amount of the processing #1, #2 to the appropriate value when the variable “Load” is more than 50% and less than 80% (procedure P3), and changes the processing amount of the processing #1, #2 to a minimum value when the variable “Load” is equal to or more than 80% (procedure P4). The processing amount of the processing #1, #2 in subsequent cycles is optimized as detailed above.

Then, at the end of program 22, a reset (initialize) flag is established in the control register 7 (procedure P5), and the instruction circuit 6 is made to reset the counters 31, 32. Because the counters 31, 32 are maintained in an enabled state, the count values are restored to zero as a result of the resetting, whereupon the count starts. After running this program 22 of the cycle header, the processing #1, #2 is executed (procedures P6 and P7).

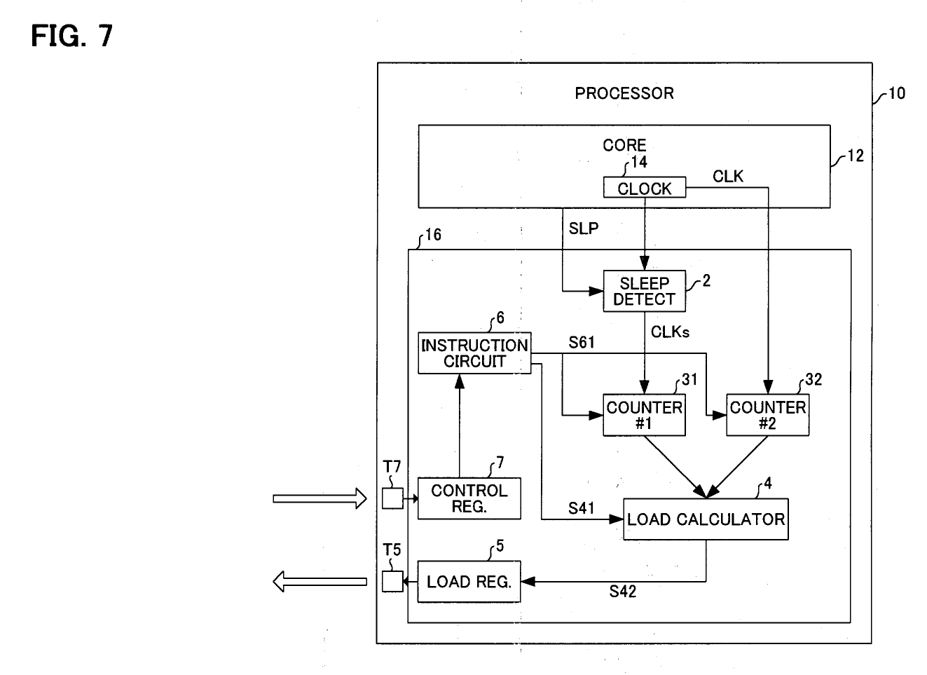

FIG. 7 shows another load monitoring circuit according to the first embodiment. In this example, the control register 7 and load register 5 are constituted so as to be accessible from the outside via external terminals T7, T5, which correspond to the control register 7 and load register 5 respectively. The external terminal T7 is constituted by a plurality of bits. Further, the control register 7 is constituted so as to permit setting of the reset flag and enable/disable flags for the counters 31, 32, and of the load calculation flag. As a result of the writing of an enable flag from the external terminal T7 to the control register 7, the instruction circuit 6 controls both the counters 31, 32 to assume an enabled state. Then, when a reset flag is also written from the external terminal T7 to the control register 7, the instruction circuit 6 initializes the counters 31, 32 to start the count for subsequent clocks. Also, when a load calculation flag is written from the external terminal T7 to the control register 7, the instruction circuit 6 supplies the load calculation instruction signal S41 to the load calculation circuit 4, calculates the load amount from the count values at this time, and writes the load amount to the load register 5. The load amount written to this load register 5 can be read out from the outside via the external terminal T5.

In this example also, by accessing the control register 7 from outside, the count can be started with optional timing, and a calculation of the load amount can be performed with optional timing. It is thus possible to measure the processor load amount in optional periods in keeping with a given objective.

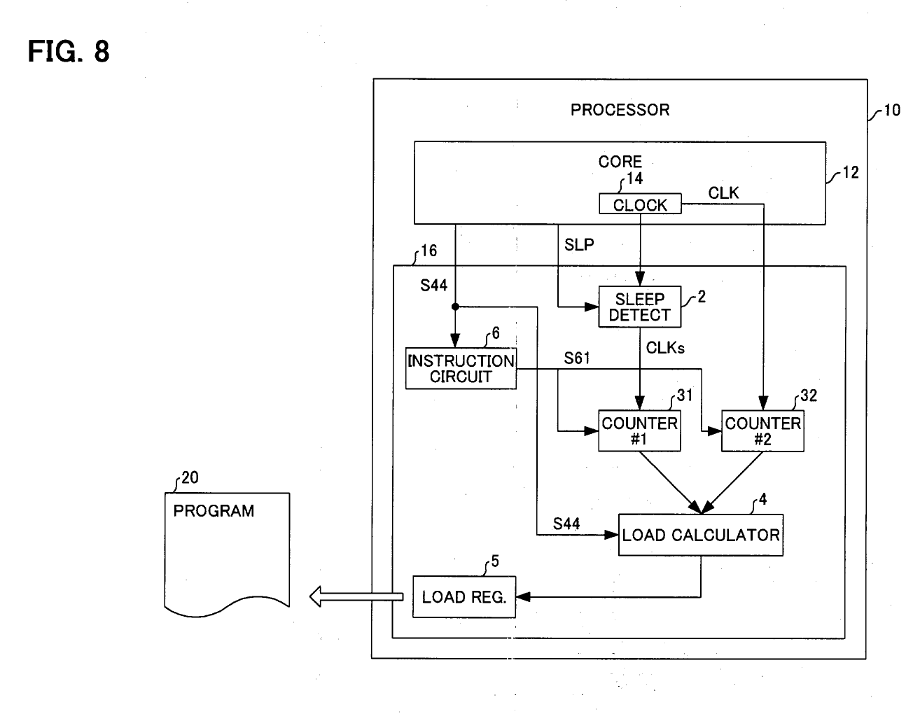

FIG. 8 shows yet another load monitoring circuit according to the first embodiment. A control register 7 is not provided in this load monitoring circuit 16. Instead, the counters 31, 32 are continuously set to an enabled state, and, in response to a read command to read the load register 5 issued by an external program, a control signal S44 is supplied by the processor core 12 to the load calculation circuit 4 and the instruction circuit 6. By way of response, the load calculation circuit 4 latches the respective count values of the counters 31, 32 to calculate the load amount, and writes the load amount to the load register. Further, by way of response, the instruction circuit 6 resets the counters 31, 32 to start a new count.

Accordingly, in this example, in response to an access command to access the load register 5, a calculation of the load from count values is performed, the counters 31, 32 being reset immediately afterwards. The serial operation above is performed in accordance with a read command to read the load register 5. In this case also, the timing for the start and termination of the load monitoring can be optionally set by an external program.

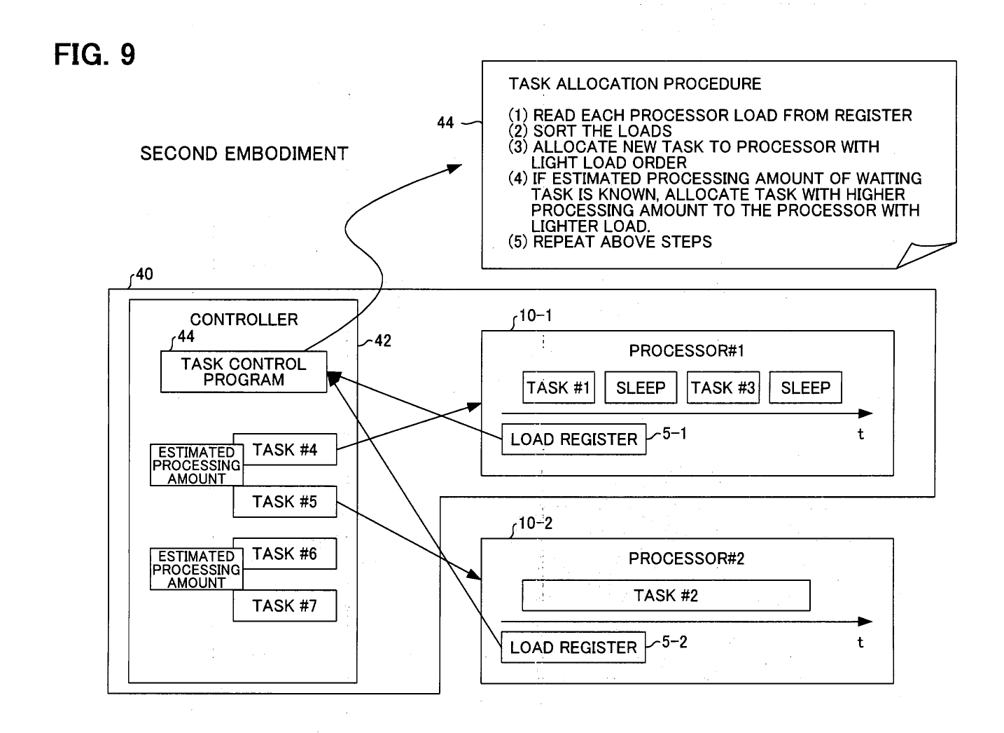

FIG. 9 shows an application example of the load monitoring circuit of a second embodiment. In this example, in a system comprising a multiprocessor that operates through linkage of a plurality of processors, the load amount of each processor is monitored in order to determine the allocation of tasks. Suppose that a given application program is run, and a required task is divided up to produce the tasks #1 to #7. The tasks thus produced are allocated sequentially by a controller 42 to two processors 10-1, 10-2. As a primary factor in the determination of this allocation, a check is performed of the current load of each processor to thereby allocate a greater number of tasks to the processor whose load is lighter. Here, by also considering the estimated processing amount of each task, the tasks whose estimated processing amounts are greater can be allocated to the processor whose load is lighter.

The two processors 10-1, 10-2 are shown in FIG. 9, and comprise a load monitoring circuit which will be described subsequently, and respective load registers 5-1, 5-2. Further, the controller 42 runs a task control program 44, and allocates the produced tasks. The procedures of this task control program 44 are detailed in FIG. 9. According to this task control program 44, first of all, the load of each processor is read out from the load registers 5-1, 5-2 and sorting is performed according to the load amounts thus read out. The task control program 44 then allocates new tasks starting with the processor with the lighter load. At such time, when the estimated processing amounts of the tasks awaiting processing are known, tasks are allocated to the processor whose load is light starting with the task with the highest estimated processing amount.

In the example of FIG. 9, the first processor 10-1 is provided in the same chip 40 as the controller 42, and the second processor 10-2 is a subprocessor. The controller 42 in the chip 40 performs optimum task allocation with respect to the processor 10-1 in the same chip, and to the processor 10-2 outside the chip.

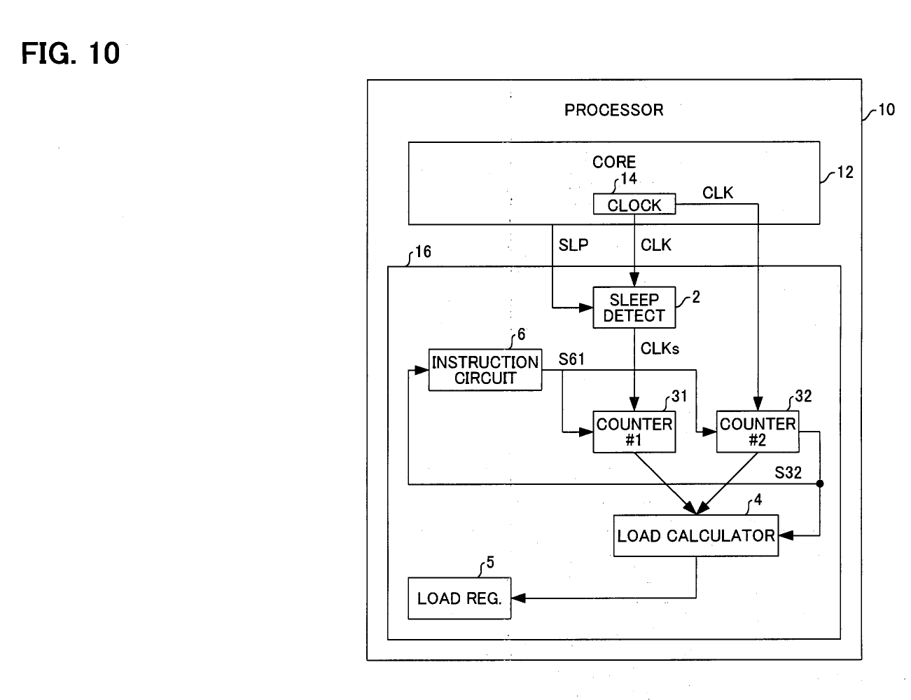

FIG. 10 shows a preferred example of a load monitoring circuit in a processor in the multiprocessor in FIG. 9. The load monitoring circuit 16 shown in the figure is not provided with a control register. Instead, the counters 31, 32 are continuously kept in an enabled state, and a reset signal (timing signal) S32 is generated every time the first counter 32, which continuously counts the system clocks CLK, overflows, or each time the first counter 32 counts up to a predetermined value. In response to this reset signal S32, the load calculation circuit 4 latches the respective count values of the counters 31, 32, calculates the ratio between these values, and writes the calculated load amount to the load register 5. In addition, in response to the reset signal S32, the instruction circuit 6 resets the counters 31, 32 to thereby start a new count. Further, the load amount written to the load register 5 can be read out by the controller in FIG. 9.

The load monitoring circuit 16 automatically calculates cyclical load amounts and writes these load amounts to the load register 5 by means of self-setting, without the load monitoring timing and the load calculation timing being controlled by a program. An external program is capable of determining the previous load amount of each processor by reading out the load amounts written to the load register 5.

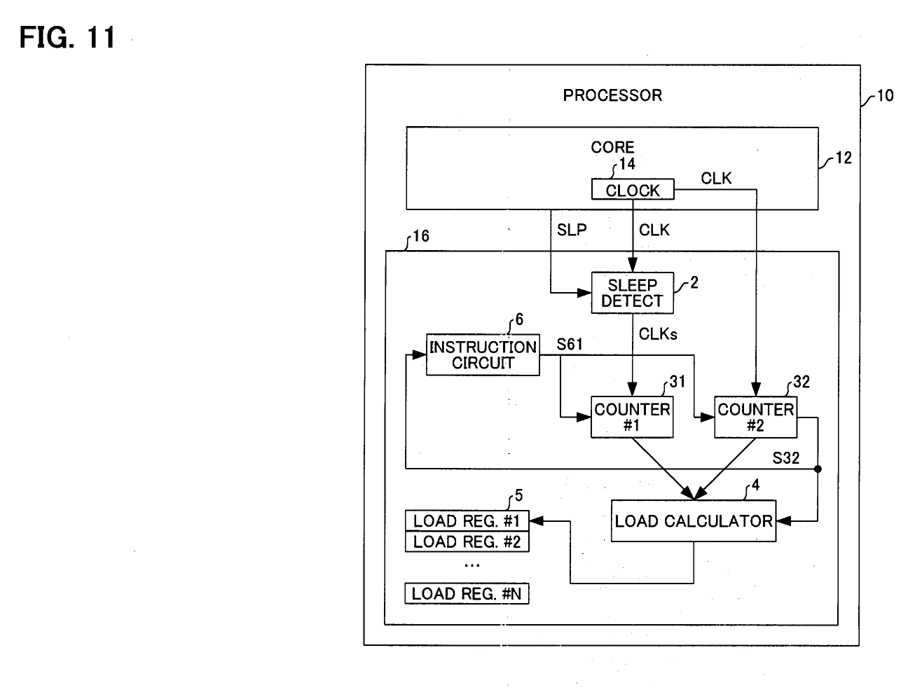

FIG. 11 shows another preferred example of a load monitoring circuit in a processor in the multiprocessor in FIG. 9. Similarly to FIG. 10, this load monitoring circuit 16 also measures the processor load amounts and writes the calculated load amounts to the load register 5 by means of self-setting. For this purpose, the load calculation and the counter resetting are performed by means of a reset signal (timing signal) S32 that is generated at the time of overflow of the first counter 32 or when this counter counts a predetermined value. In addition, in this example, the load register 5 comprises a plurality of registers and has a FIFO configuration, such that calculated load amounts are written sequentially.

The load monitoring circuit in FIG. 11 is set such that the overflow cycle of the counter 32 is comparatively short. Accordingly, the period during which the load monitoring circuit monitors the load amounts is also set to be comparatively short. Further, the load amounts found in each period are sequentially written to and held by the load registers 5. In other words, the load amounts of each fixed interval are sequentially written to the load registers 5. The program performing monitoring from the outside reads out, with predetermined timing, the plurality of load amounts in the load registers 5 which have been stored thus far. As a result, the external program is capable of determining the history of the processor load amounts.

Therefore, the program required to determine the load amounts is capable of determining the load amounts from an optional time by suitably reading out the history of the load amounts stored in the load registers 5 without controlling the counter start timing. The program is also capable of lightening the program load without being required to control the resetting of the counters in each of a plurality of load amount monitoring periods.

According to the present embodiment described hereinabove, a load monitoring circuit is provided in the processor to permit an external program or the like to measure load amounts with optional timing and to read out these load amounts. It is therefore possible to control a variety of processors by using these load amounts.

According to the present invention described hereinabove, the monitoring timing of a load monitoring circuit provided in a processor can be optionally set from the outside.

What is claimed is:

1. A microprocessor that operates in synchronization with clocks, comprising:
a first counter for counting said clocks;
a second counter for counting said clocks during periods when said microprocessor is in a sleep state;
a counter control circuit for controlling resetting or enabling/disabling of said first and second counters;
a control register for directing an operation of said counter control circuit;
a load calculation circuit for finding a load of said microprocessor from the respective count values of said first and second counters; and
a load monitoring circuit including a load register for storing said load found by said load calculation circuit.

2. The microprocessor according to claim 1, wherein said control register and load register are accessible by a program or an external terminal.

3. The microprocessor according to claim 1, wherein said load calculation circuit divides the value of the second counter by the value of the first counter.

4. The microprocessor according to claim 2, wherein, when said program writes a reset flag to said control register, said counter control circuit resets said first and second counters to start the count; and, when said program performs reading of said load register, said load calculation circuit performs a load calculation by latching the respective count values of said first and second counters, and outputs the calculated load to said load register.

5. The microprocessor according to claim 2, wherein, when a reset flag is written to said control register by said external terminal, said counter control circuit resets said first and second counters to start the count; and, when a load calculation flag is written to the control register, said counter control circuit causes said load calculation circuit to perform a load calculation by latching the respective count values of said first and second counters, and to output the calculated load to said load register.

6. The microprocessor according to claim 2, wherein, when said program performs reading of said load register, said load calculation circuit performs a load calculation by latching the respective count values of said first and second counters, and outputs the calculated load to said load register, and said counter control circuit resets said first and second counters to start the count.

7. A microprocessor that operates in synchronization with clocks, comprising a load monitoring circuit which comprises:
a first counter for counting said clocks;
a second counter for counting said clocks during periods when said microprocessor is in a sleep state;
a counter control circuit for controlling resetting of said first and second counters;
a load calculation circuit for finding a load of said microprocessor from the respective count values of said first and second counters; and
a load register for storing said load found by said load calculation circuit,
wherein, in response to a timing signal generated when said first counter reaches a predetermined count value, said load calculation circuit finds said load and outputs said load to said load register, and said counter control circuit resets said first and second counters to start the count.

8. The microprocessor according to claim 7, wherein said load calculation circuit divides the value of the second counter by the value of the first counter.

9. The microprocessor according to claim 7, wherein said load register comprises a plurality of storage regions and stores a load history.

10. The microprocessor according to claim 7, wherein said load register is accessible by a program or an external terminal.

11. A multiprocessor system including a plurality of microprocessors that operate in synchronization with clocks, wherein said plurality of microprocessors each comprises a load monitoring circuit comprising:
a first counter for counting said clocks;
a second counter for counting said clocks during periods when said microprocessor is in a sleep state;
a counter control circuit for controlling resetting of said first and second counters;
a load calculation circuit for finding a load of said microprocessor from the respective count values of said first and second counters; and
a load register for storing said load found by said load calculation circuit,
wherein, in response to a timing signal generated when said first counter reaches a predetermined count value, said load calculation circuit finds said load and outputs said load to said load register, and said counter control circuit resets said first-and second counters to start the count, and
said multiprocessor system further comprising a controller for controlling an allocation of tasks to said plurality of microprocessors, wherein said controller reads out the respective loads of the load registers of said microprocessors, and allocates said tasks to said microprocessors in accordance with the magnitude of the loads.

12. The multiprocessor system according to claim 11, wherein said load register comprises a plurality of storage regions and stores a load history.
